(19) United States
(12) Patent Application Publication
(10) Pub. No.: US 2011/0078576 A1
(43) Pub. Date: Mar. 31, 2011

(54) METHODS, APPARATUSES, AND COMPUTER PROGRAM PRODUCTS FOR FACILITATING MANAGEMENT OF A COMPUTING SYSTEM

(75) Inventor: Eric Jordan, Belchertown, MA (US)

(73) Assignee: McKesson Financial Holdings Limited

(21) Appl. No.: 12/570,485

(22) Filed: Sep. 30, 2009

(51) Int. Cl. G06F 3/048; G06F 15/16

(52) U.S. Cl. 715/738

(57) ABSTRACT

Methods, apparatuses, and computer program products are provided for facilitating management of a computing system comprising a server. A method may include interfacing with the server. The method may further include providing a graphical user interface facilitating user management of the computing system. The graphical user interface may provide access to a library of selectable scripts configured for execution on the server. Each selectable script may be configured to perform a management function when executed. The management function may comprise a management function for managing one or more of the computing system, the server, an operating system implemented on the server, a database to which access is provided by the computing system, or an application provided by the computing system. Corresponding apparatuses and computer program products are also provided.

### TECHNOLOGICAL FIELD

Embodiments of the present invention relate generally to information technology and, more particularly, relate to methods, apparatuses, and computer program products for facilitating management of a computing system.

### BACKGROUND

Modern computing systems may be deployed in environments, such as in hospitals and medical clinics, in which the computing systems provide mission-critical application and data services. Accordingly, it may be critical to ensure that such computing systems are functioning properly to minimize system downtime, which may severely impact services, such as healthcare services, which may be dependent on the computing systems.

Managing modern computing systems may be quite complicated and may be beyond the technical ability of all but the most highly trained information technology personnel. Environments in which computing systems are deployed may not be sufficiently staffed with highly trained information technology personnel who are well versed in diagnosing and triaging issues with the deployed computing systems. In this regard, these computing systems may include applications and database back ends that may be difficult for untrained personnel to manage. Moreover, many computing systems are implemented using one or more servers running on a Linux, Unix, or a Unix-like operating system having a command line shell interface that may be unfamiliar to personnel more used to Microsoft Windows® or other common graphical desktop operating systems.

Even trained information technology personnel may have trouble remembering available computing system management and triage routines and how and when to execute the routines. Further, the various routines may require execution within specific locations (e.g., directories) in a file system hierarchy and this may further complicate the job of information technology personnel when managing a computing system.

Such complexity inherent in managing modern computing systems may increase the risk of system errors and/or down-time. Further, this complexity may inhibit a desirable quick triage and resolution of system issues, which may result in an undesirably long period of system down time.

### BRIEF SUMMARY OF SOME EXAMPLES OF THE INVENTION

Methods, apparatuses, and computer program products are therefore provided for facilitating management of a computing system. In this regard, methods, apparatuses, and computer program products are provided that may provide several advantages to computing systems, personnel tasked with managing computing systems, environments in which computing systems are deployed, and users of computing systems. Embodiments of the invention provide for a graphical user interface facilitating user management of a computing system. In this regard, embodiments of the invention provide a graphical user interface serving as a one-stop portal for information and routines for managing a computing system. In some embodiments of the invention, the graphical user interface provides access to a library of selectable scripts configured for performing a management function when executed on a server of the computing system. Accordingly, by way of some embodiments of the invention, users are enabled to manage a computing system using an intuitive graphical interface without having to navigate a command line shell to perform system management functions. The graphical interface may accordingly aid in maintenance of a computing system such that system downtime may be reduced.

In a first example embodiment, a method for facilitating management of a computing system comprising a server is provided. The method of this embodiment comprises interfacing with the server. The method of this embodiment further comprises providing a graphical user interface facilitating user management of the computing system. The graphical user interface of this embodiment provides access to a library of selectable scripts configured for execution on the server. Each selectable script of this embodiment is configured to perform a management function when executed. The management function of this embodiment comprises a management function for managing one or more of the computing system, the server, an operating system implemented on the server, a database to which access is provided by the computing system, or an application provided by the computing system.

In another example embodiment, an apparatus for facilitating management of a computing system comprising a server is provided. The apparatus of this embodiment comprises a processor configured to cause the apparatus to interface with the server. The processor of this embodiment is further configured to cause the apparatus to provide a graphical user interface facilitating user management of the computing system. The graphical user interface of this embodiment provides access to a library of selectable scripts configured for execution on the server. Each selectable script of this embodiment is configured to perform a management function when executed. The management function of this embodiment comprises a management function for managing one or more of the computing system, the server, an operating system implemented on the server, a database to which access is provided by the computing system, or an application provided by the computing system.

In another example embodiment, a computer program product for facilitating management of a computing system comprising a server is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction of this embodiment is configured for interfacing with the server. The second program instruction of this embodiment is configured for providing a graphical user interface facilitating user management of the computing system. The graphical user interface of this embodiment provides access to a library of selectable scripts configured for execution on the server. Each selectable script of this embodiment is configured to perform a management function when executed. The management function of this embodiment comprises a management function for managing one or more of the computing system, the server, an operating system implemented on the server, a database to which access is provided by the computing system, or an application provided by the computing system.

In another example embodiment, an apparatus for facilitating management of a computing system comprising a server is provided. The apparatus of this embodiment comprises means for interfacing with the server. The apparatus of this embodiment further comprises means for providing a graphical user interface facilitating user management of the computing system. The graphical user interface of this embodiment provides access to a library of selectable scripts configured for execution on the server. Each selectable script of this embodiment is configured to perform a management function when executed. The management function of this embodiment comprises a management function for managing one or more of the computing system, the server, an operating system implemented on the server, a database to which access is provided by the computing system, or an application provided by the computing system.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates one embodiment of a computing system and the level of technical staffing that may be required for managing the computing system;

FIG. 2 illustrates an apparatus for facilitating management of a computing system according to an exemplary embodiment of the present invention;

FIG. 3 illustrates a system for facilitating management of a computing system according to an exemplary embodiment of the present invention;

FIG. 4 illustrates a computing system according to an exemplary embodiment of the present invention;

FIG. 5 illustrates a diagram of a system supporting a web-based implementation of a graphical user interface for facilitating management of a computing system according to an exemplary embodiment of the invention;

FIG. 6 illustrates a file structure of a web-based implementation of a graphical user interface for facilitating management of a computing system according to an exemplary embodiment of the invention;

FIG. 7 illustrates a screenshot of a graphical user interface for facilitating management of a computing system according to an exemplary embodiment of the invention;

FIG. 8 illustrates a detailed screen shot of a portion of a tabbed navigational bar facilitating navigation of a graphical user interface for facilitating management of a computing system according to an exemplary embodiment of the invention;

FIG. 9 illustrates a screenshot of a graphical user interface for facilitating management of a computing system according to an exemplary embodiment of the invention;

FIG. 10 illustrates a screenshot of a graphical user interface for facilitating management of a computing system according to an exemplary embodiment of the invention;

FIG. 11 illustrates a screenshot of a graphical user interface for facilitating management of a computing system according to an exemplary embodiment of the invention;

FIG. 12 illustrates a tool bar for facilitating user access to system management tools in a graphical user interface for facilitating management of a computing system according to an exemplary embodiment of the invention;

FIG. 13 illustrates information that may be provided to a user by a graphical user interface for facilitating management of a computing system according to an exemplary embodiment of the invention; and

FIG. 14 illustrates a flowchart according to an exemplary method for facilitating management of a computing system according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

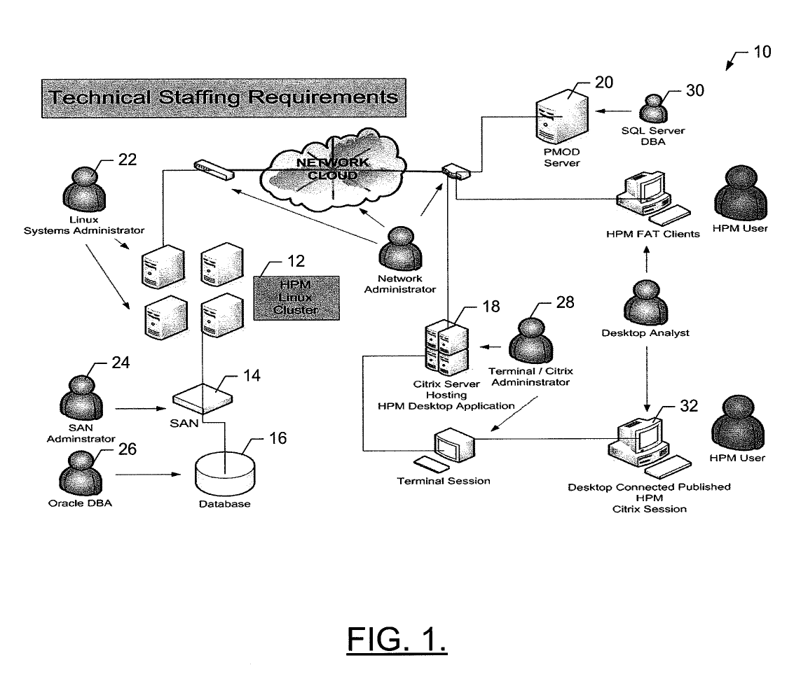

FIG. 1 illustrates one embodiment of a computing system and the level of technical staffing that may be required for managing the computing system. In this regard, FIG. 1 illustrates the level of technical staffing that may be required for managing a computing system 10 implementing McKesson Information Solution's Horizon Performance Manager (HPM) absent implementation of an embodiment of the present invention. As illustrated in FIG. 1, the computing system 10 includes a number of components. A cluster of servers 12 may run on a Linux operating system and may provide the HPM backend. The computing system 10 may further comprise a storage area network (SAN) 14 and a database 16. The system 10 may additionally comprise a Citrix® server 18, which may host the HPM desktop application and provide the HPM desktop application to remote user terminals (e.g., the desktop computer 32). The system 10 may also comprise a PMOD (Pathways Modeling) server 20 implementing McKesson Information Solution's Pathways Modeling product, which may comprise a structured queerly language (SQL) database.

Each of these components of the system 10 may require unique management routines for managing the respective components. Accordingly, in the absence of a simple one-stop, user friendly tool for facilitating management of the system 10, the complexity of the system 10 may require staffing by several specially trained system administrators, each of whom may be tasked with managing a single component of the system 10. For example, the cluster of servers 12 may be administered by a Linux systems administrator 22, who may be specially trained to manage Linux servers. A SAN administrator 24 may be responsible for managing the SAN 14. The database 16 may, for example, comprise an Oracle® database and may be managed by an administrator 26 specially trained in the administration of Oracle® databases. An administrator 28 specially trained in the administration of Citrix® servers and/or the HPM desktop application may manage the Citrix® server 18. Similarly, an administrator 30 specially trained in the administration of SQL server and/or SQL database administration may manage the PMOD server 20.

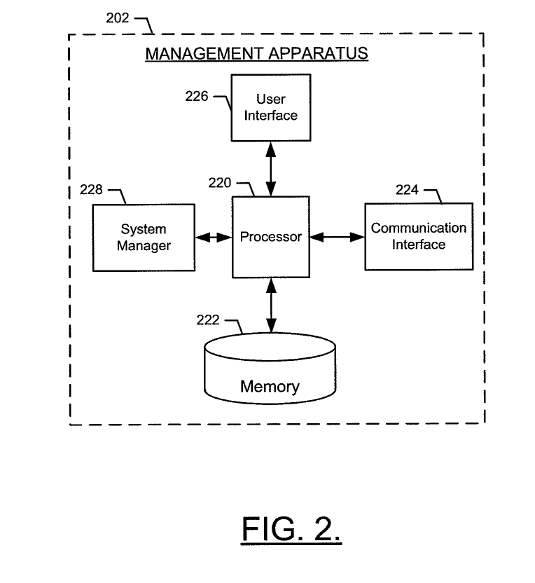

Embodiments of the invention provide methods, apparatuses, and computer program products for facilitating management of a computing system, such as the computing system 10, that may advantageously reduce the level of technical staffing required for managing a computing system and/or increase the ability of information technology personnel to efficiently diagnose, triage, and repair problems that may arise with a computing system. In this regard, FIG. 2 illustrates a management apparatus 202 for facilitating management of a computing system according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 2 illustrates one example of a configuration of a management apparatus for facilitating management of a computing system, numerous other configurations may also be used to implement embodiments of the present invention.

The management apparatus 202 may be embodied as a server, desktop computer, laptop computer, mobile terminal, mobile computer, mobile phone, mobile communication device, audio/video player, television device, network node, multiple computing devices in communication with each other, any combination thereof, and/or the like. In an exemplary embodiment the management apparatus 202 includes various means, such as a processor 220, memory 222, communication interface 224, user interface 226, and system manager 228 for performing the various functions herein described. These means of the management apparatus 202 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 222) that is executable by a suitably configured processing device (e.g., the processor 220), or some combination thereof.

The processor 220 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 220 comprises a plurality of processors. The plurality of processors may be embodied on a single computing device or may be distributed across a plurality of computing devices collectively configured to function as the management apparatus 202. The plurality of processors may be in operative communication with each other and may be collectively configured to perform one or more functionalities of the management apparatus 202 as described herein. In an exemplary embodiment, the processor 220 is configured to execute instructions stored in the memory 222 or otherwise accessible to the processor 220. These instructions, when executed by the processor 220, may cause the management apparatus 202 to perform one or more of the functionalities of the management apparatus 202 as described herein. As such, whether configured by hardware or software methods, or by a combination thereof, the processor 220 may comprise an entity capable of performing operations according to embodiments of the present invention while configured accordingly. Thus, for example, when the processor 220 is embodied as an ASIC, FPGA or the like, the processor 220 may comprise specifically configured hardware for conducting one or more operations described herein. Alternatively, as another example, when the processor 220 is embodied as an executor of instructions, such as may be stored in the memory 222, the instructions may specifically configure the processor 220 to perform one or more algorithms and operations described herein.

The memory 222 may include, for example, volatile memory, non-volatile memory, or some combination thereof. Although illustrated in FIG. 2 as a single memory, the memory 222 may comprise a plurality of memories. The plurality of memories may be embodied on a single computing device or distributed across a plurality of computing devices. The memory 222 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 222 may be configured to store information, data, applications, instructions, or the like for enabling the management apparatus 202 to carry out various functions in accordance with exemplary embodiments of the present invention. For example, in at least some embodiments, the memory 222 is configured to buffer input data for processing by the processor 220. Additionally or alternatively, in at least some embodiments, the memory 222 is configured to store program instructions for execution by the processor 220. The memory 222 may store information in the form of static and/or dynamic information. This stored information may be stored and/or used by the system manager 228 during the course of performing its functionalities.

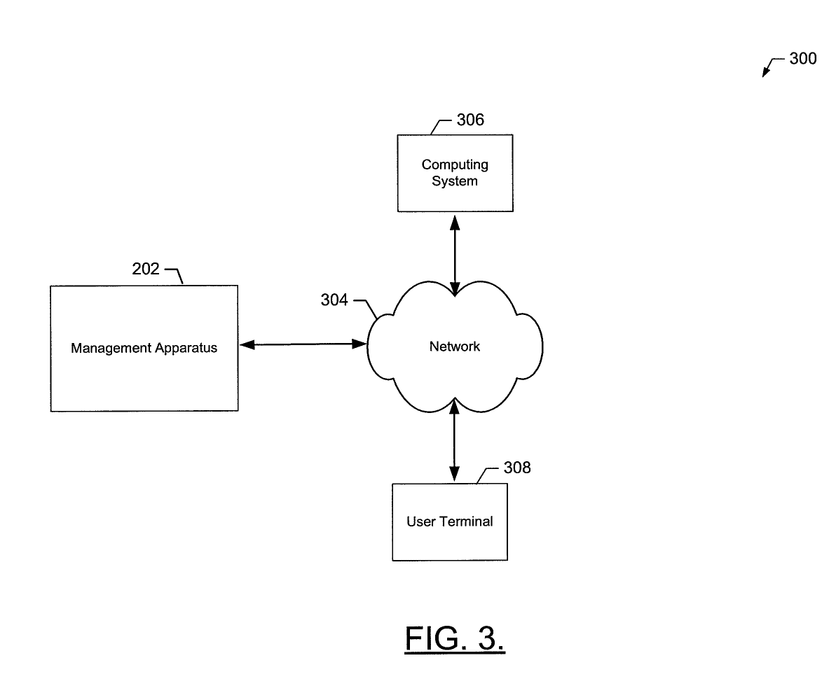

The communication interface 224 may be embodied as any device or means embodied in circuitry, hardware, a computer program product comprising computer readable program instructions stored on a computer readable medium (e.g., the memory 222) and executed by a processing device (e.g., the processor 220), or a combination thereof that is configured to receive and/or transmit data from/to another device or system, such as, for example, a server, a computing system (e.g., the computing system 306 illustrated in FIG. 3), a user terminal (e.g., the user terminal 308 illustrated in FIG. 3), a data source, and/or the like. In at least one embodiment, the communication interface 224 is at least partially embodied as or otherwise controlled by the processor 220. In this regard, the communication interface 224 may be in communication with the processor 220, such as via a bus. The communication interface 224 may include, for example, an antenna, a transmitter, a receiver, a transceiver and/or supporting hardware or software for enabling communications with another computing device. The communication interface 224 may be configured to receive and/or transmit data using any protocol that may be used for communications between computing devices. The communication interface 224 may additionally be in communication with the memory 222, user interface 226, and/or system manager 228, such as via a bus.

The user interface 226 may be in communication with the processor 220 to receive an indication of a user input and/or to provide an audible, visual, mechanical, or other output to a user. As such, the user interface 226 may include, for example, a keyboard, a mouse, a joystick, a display, a touch screen display, a microphone, a speaker, and/or other input/output mechanisms. In some embodiments wherein the management apparatus 202 is embodied as a server, aspects of the user interface 226 may be reduced or the user interface 226 may even be eliminated. Alternatively, in some embodiments wherein the management apparatus 202 is embodied as a server, at least some aspects of the user interface 226 may be embodied on an apparatus used by a user that is in communication with the management apparatus 202, such as for example, the user terminal 308 illustrated in FIG. 3. The user interface 226 may provide means for facilitating a user to view a graphical user interface facilitating user management of a computing system and to interact with the graphical user interface, such as to make a selection of an option presented by the graphical user interface. The user interface 226 may be in communication with the memory 222, communication interface 224, and/or system manager 228, such as via a bus.

The system manager 228 may be embodied as various means, such as circuitry, hardware, a computer program product comprising computer readable program instructions stored on a computer readable medium (e.g., the memory 222) and executed by a processing device (e.g., the processor 220), or some combination thereof and, in one embodiment, is embodied as or otherwise controlled by the processor 220. In embodiments wherein the system manager 228 is embodied separately from the processor 220, the system manager 228 may be in communication with the processor 220. The system manager 228 may further be in communication with one or more of the memory 222, communication interface 224, or user interface 226, such as via a bus.

FIG. 3 illustrates a system 300 for facilitating management of a computing system according to an exemplary embodiment of the present invention. In this regard, FIG. 3 illustrates a system wherein the management apparatus 202 is in communication with a computing system 306 over a network 304. Although illustrated in FIG. 3 as separate from the computing system 306, in some embodiments the management apparatus 202 is embodied on a server or other computing device within the computing system 306. The network 304 may comprise a wireless network (e.g., a cellular network, wireless local area network, wireless personal area network, wireless metropolitan area network, and/or the like), a wireline network, or some combination thereof, and in some embodiments comprises the internet. The computing system 306 may comprise any computing system, which may be managed at least in part by way of the management apparatus 202. For example, the computing system 306 may comprise at least a portion of the computing system 10 illustrated in FIG. 1.

In some embodiments, the management apparatus 202 comprises and/or is embodied as one or more servers. In such embodiments, the management apparatus may be in communication with one or more remote user terminals 308 over the network 304. The user terminal 308 may comprise any device configured for use by a user to access system management services provided by the management apparatus 202 over the network 304. In this regard, the user terminal 308 may be embodied as a desktop computer, laptop computer, mobile terminal, mobile computer, mobile phone, mobile communication device, audio/video player, television device, any combination thereof, and/or the like.

In embodiments wherein a user terminal 308 remote from the management apparatus 202 is used to access computing system management functionality provided by the management apparatus 202, elements of the management apparatus 202 that were described with respect to FIG. 2 and functionality attributed thereto may be distributed between the management apparatus 202 and user terminal 308. For example, the system manager 228 may be distributed between the management apparatus 202 and user terminal 308, such that functionality attributed to the system manager 228 may be performed by the management apparatus 202 and/or by the user terminal 308. Additionally or alternatively, where the system manager 228 is said to be configured to cause a graphical user interface or other data to be displayed, it will be appreciated that the system manager 228 may be configured to cause the graphical user interface and/or other data to be displayed on a display connected to the management apparatus 202 and/or may be configured to cause transmission of the data to be displayed via the communication interface 224 to a user terminal 308 such that the graphical user interface and/or other data may be displayed on a display in operative communication with (e.g., embodied on or otherwise connected to) the user terminal 308. Similarly, where receipt of a selection of an option (e.g., a selection of a selectable script) and/or receipt of other user input is described, it will be appreciated that the user may be providing the selection or input via the user interface 226 and/or may be interacting with a user terminal 308 (e.g., via a keyboard, mouse, touch screen display, and/or other input means) such that the input and/or selection is transmitted from the user terminal 308 to the management apparatus 202, where it may be received by the communication interface 224 and/or system manager 228. Further, program instructions, information, and/or other data said to be stored in the memory 222 may be stored at the management apparatus 202 and/or may be stored on the user terminal 308. Accordingly, embodiments of the invention wherein the management apparatus 202 is embodied as one or more servers providing a graphical user interface to a user terminal 308 may allow a user to manage the computing system 306 from any location where a user terminal 308 may access the management apparatus 102 through the network 304.

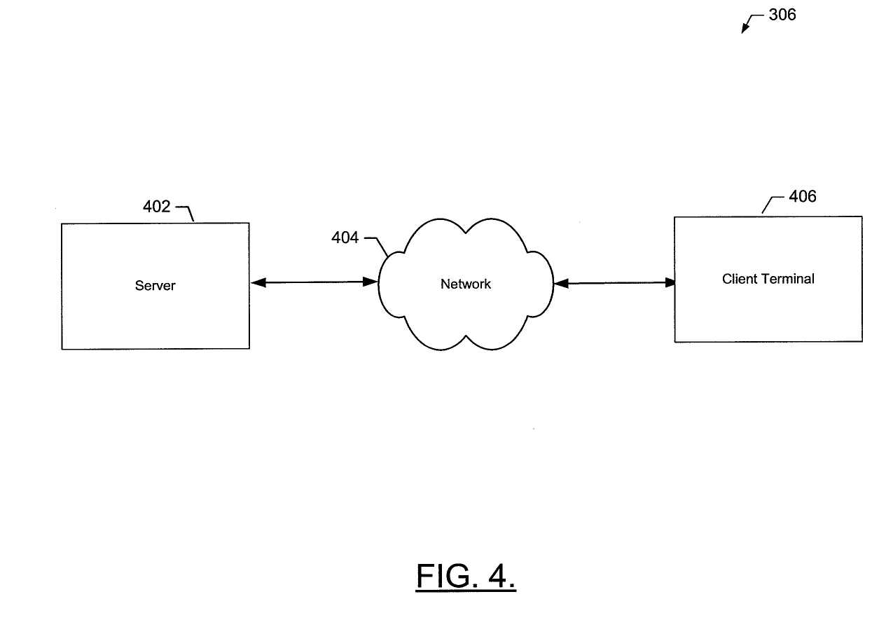

FIG. 4 illustrates a computing system 306 according to an exemplary embodiment of the present invention. As illustrated in FIG. 4, a computing system 306 may include a plurality of computing devices and/or other components interfaced over a network 404. The network 404 may comprise a wireless network (e.g., a cellular network, wireless local area network, wireless personal area network, wireless metropolitan area network, and/or the like), a wireline network, or some combination thereof, and in some embodiments comprises the internet. In some embodiments, the network 404 may comprise at least a portion of the network 304. The computing system 306 may include one or more servers 402, which may be configured to store and/or provide access to applications, services, application data, database data, and/or other data for implementing a service or function provided by the computing system 306. For example, the computing system 306 may comprise a system for healthcare data management, such as, for example, an HPM system. In such embodiments, the server(s) 402 may store and/or provide access to medical data, database backend(s) supporting the medical data, applications for analysis of the medical data, and/or the like. The server(s) 402 may implement a Linux, Unix, or Unix-like operating system. The computing system 306 may further comprise one or more client terminals 406.

A client terminal 406 may be embodied as a desktop computer, laptop computer, mobile terminal, mobile computer, mobile phone, mobile communication device, audio/video player, television device, any combination thereof, and/or the like. In one embodiment, the client terminal 406 comprises a user terminal 308. A client terminal 406 may be configured to communicate with one or more servers 402 over the network 404 to access services or functionality provided by the computing system 306 (e.g., by the one or more servers 402).

As described previously, the management apparatus 202 may comprise a component of the computing system 306. Accordingly, although not illustrated in FIG. 4, the computing system 306 may additionally comprise a management apparatus 202 in communication with the server 402 and/or client terminal 406 over the network 404. Alternatively, the management apparatus 202 may be embodied on the server 402 and/or on the client terminal 406.

Further, although not illustrated in FIG. 4, it will be appreciated that a computing system 306 may additionally or alternatively comprise other components for implementing and providing an application, function, or service provided by the computing system 306. In this regard, the computing system 306 may comprise at least some of the elements illustrated in the computing system 10 of FIG. 1.

In some embodiments, the system manager 228 is configured to interface with a server (e.g., a server 402) that resides on the computing system 306. In this regard, the system manager 228 may be configured to access the server and data, files, applications, scripts, and/or the like stored thereon or that are otherwise accessible through the server. The system manager 228 may be further configured to navigate a file system hierarchy (e.g., a directory structure) implemented on the server and to execute applications, scripts, and/or the like for managing the computing system 306 within a location (e.g., a directory) of the file system hierarchy. The system manager 228 may be configured to interface with the server by executing a stand-alone process configured to interface with the server.

The system manager 228 is further configured in some embodiments of the invention to provide a graphical user interface, also referred to as a “One Stop Portal,” facilitating user management of the computing system. In this regard, the system manager 228 may be configured to cause the graphical user interface to be displayed such that a user may interact with the graphical user interface to manage the computing system 306. The graphical user interface may provide access to tools, information, instructions, and/or the like for managing one or more elements of the computing system 306. In this regard, the graphical user interface may comprise a “one stop” portal for managing the computing system 306 so as to streamline management of the computing system 306 and present information in such a way to make computing system management more intuitive and user friendly. Consequently, management efficiency may be improved.

In some embodiments, the graphical user interface is configured to provide access to one or more selectable access options. These access options may comprise, for example, script options, log search options, information options, and/or the like, as will be further described. In this regard, the graphical user interface is configured, in some embodiments, to provide access to a library of selectable scripts (e.g., script options) configured for execution on one or more servers (e.g., a server 402) of the computing system 306 with which the system manager 228 is interfaced. These scripts may comprise predefined scripts, functions, applications, and/or the like that are configured to perform a management function for managing the computing system 306 when executed. In this regard, a management function may comprise a function for managing a server of the computing system, a database (e.g., database data, the database backend structure, and/or the like) to which access is provided by the computing system 306, an application to which access is provided by the computing system 306, and/or the like. A management function may, for example, facilitate diagnosis of a problem with the computing system 306 or an entity thereof and/or repair of a problem with the computing system 306 or entity thereof.

The graphical user interface may be further configured to provide access to a log search option comprising access to one or more searchable log libraries (e.g., server log libraries). In this regard, the graphical user interface may provide a user-friendly search interface to allow a user to quickly and intuitively search log files to diagnose potential errors or other issues with the server or computing system with an automatic search operation rather than having to manually search through log files.

The graphical user interface may be further configured to provide access to information options. These information options may include, for example, database specific management information (e.g., manufacture instruction files, solution resources, libraries and/or the like), application specific management information (e.g., manufacture instruction files, solution resources, libraries and/or the like), and/or the like. Additionally or alternatively, the graphical user interface may be configured to provide access to information options comprising information about a status of the network 304, network 404, and/or other network, information about a status of one or more network nodes (e.g., servers, client terminals, and/or the like) of the computing system 306, information about applications (e.g., application names, versions, and/or the like) that are installed on the server or otherwise implemented by the computing system 306, information about an operating system installed on the server (e.g., operating status, version of operating system installed, version of operating system kernel installed, parameters of the installed kernel, disk usage information, any cron jobs that are active or otherwise scheduled for execution, and/or the like).

The system manager 228 is configured in some embodiments to determine a selection via the graphical user interface of an access option (e.g., a script option, log search option, information option, and/or the like) provided by the graphical user interface. The selection may comprise any user selection via a user interface in communication with the graphical user interface, such as via the user interface 226, user interface of a user terminal 308, and/or the like. In response to the selection, the system manager 228 may provide access to the selected access option and/or execute a function associated with the access option.

For example, when the selected access option comprises a selected script from a provided library of selectable scripts, the system manager 228 may be configured to access, in response to the selection, the selected script. The system manager 228 may be further configured to then cause execution of the selected script. The system manager 228 may be configured to cause execution of the selected script on the server (e.g., the server 402). In this regard, the system manager 228 may issue a command to the server and the server may, in response to the command, execute the script, which may be stored on the server. It will be appreciated that the selected script may be configured for execution on an operating environment (e.g., an operating system) implemented on the server. For example, in embodiments wherein the server on which the script is executed implements a version of a Linix, Unix, or a Unix-like operating system, the script may be configured for execution on that implemented operating system.

At least a portion of the selected script may be configured to execute on a location within a file system hierarchy on the server. This location may be determined based at least in part upon the management function the selected script is configured to perform. For example, if the script is configured to perform a management function for managing an application on the server, at least a portion of the script may be configured to execute in a location at which files and/or data supporting the application are stored. Accordingly, the system manager 228 may be configured to cause execution of at least a portion of the selected script in that location within the file system hierarchy. In this regard, the selected script may include commands to change a directory of the file system hierarchy to an appropriate directory for execution of the management-related commands of the script and thus causing execution of the script itself may automatically cause at least a portion of the selected script to execute in the appropriate location. Additionally or alternatively, the system manager 228 may be configured to navigate the file system hierarchy to an appropriate location at which the script should be executed and then cause the script to be executed. For example, the script may be associated with a file system location and the system manager 228 may be configured to lookup the location associated with the selected script and then navigate to and cause execution of the script at the associated location.

In some embodiments, the system manager 228 is configured to provide the graphical user interface by providing, via a web server, a web-based graphical user interface. This system manager 228 may be configured to provide this web-based graphical user interface to a network terminal (e.g., a user terminal 308) in network communication with the management apparatus 202 and/or the computing system 306 such that the web-based graphical user interface is displayable on a display in operative communication with the network terminal. The web server may be configured to operate over a port of the server with which the system manager 228 is configured to interface. For example, if the computing system 306 comprises a computing system implementing HPM and the system manger 228 is configured to interface with an HPM server, the web server may be configured to operate over port 9090. Such a web server may be implemented by and/or under the control of the system manager 228, or may alternatively comprise a stand-alone web server with which the system manager 228 is configured to communicate.

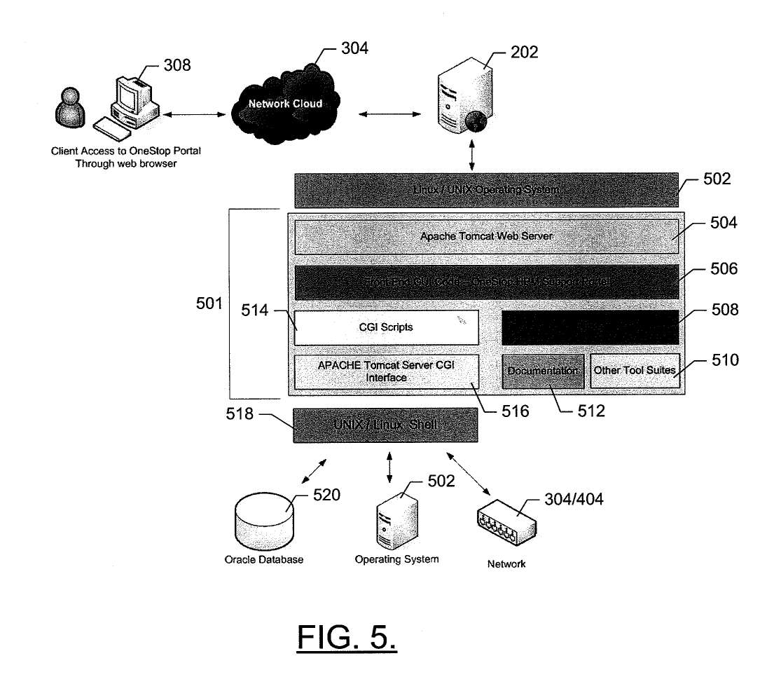

FIG. 5 illustrates a diagram of a system supporting such a web-based implementation of a graphical user interface for facilitating management of a computing system according to an exemplary embodiment of the invention. As illustrated in the embodiment of FIG. 5, the system manager 228 may be configured to interface with a server implementing a Linux/Unix/Unix-like operating system 502. The graphical user interface (e.g., One Stop Support Portal) may be supported by a plurality of layers 501. The layers 501 may comprise a web server, such as, for example, the Apache Tomcat Web Server 404. The layers 501 may further comprise a layer 506 comprising a computer program product comprising a code stored on the memory 222 and/or specially configured hardware for implementing the graphical user interface. In this regard, system manager 228 may comprise and/or may control operation of the layer 506. The layers 501 may further comprise layers supporting the access options provided by the graphical user interface. Several example layers are illustrated in FIG. 5. The illustrated layers supporting the access options are provided by way of example and not by way of limitation, and may depend on the access options to which access is provided by a particular implementation of a graphical user interface in accordance with embodiments of the invention. A links layer 508 may be configured to support links (e.g., hyperlinks) to additional information for managing the computing system 306. The other tool suites layer 510 may be configured to support tool suites for managing the system 306, which may be accessed through the graphical user interface. A documentation layer 512 may be configured to facilitate storage of and/or support access to documentation (e.g., information) for managing the computing system 306. A scripts layer 514 (e.g., a CGI scripts layer) may be configured to facilitate storage of and/or support access to a library of selectable scripts to which access is provided by the graphical user interface. It will be appreciated, however, that CGI (Common Gateway Interface) is just one example of a scripting language that may be used to support scripts that may be accessed through the graphical user interface and additional or alternative scripting languages, such as, for example, Pearl, may also be used. An Apache Tomcat Server CGI interface layer 516 may be configured to support an interface allowing scripts to be executed over the web server. It will be appreciated, however, that the interface layer 516 may be configured to support an interface between any web server and any scripting language used and thus is not limited to embodiment as an Apache Tomcat Server CGI interface.

The system of FIG. 5 may further include an operating system shell (e.g., a Unix/Linux shell) 518 that may comprise an interface component of the operating system 502 and which may be used to interface with and/or access components of the computing system 306. Accordingly, the operating system shell may, for example, be accessed by the system manager 228 to interface with the operating system 502, the network 304 and/or network 404, and/or a database stored on the server, such as, for example, an Oracle® database 520. It will be appreciated, however, that components of the system illustrated in FIG. 5 may be readily swapped for functional equivalents and/or alternatives in accordance with embodiments of the invention. Accordingly, embodiments are not limited to use of the Apache Tomcat web server, CGI scripting language, Unix/Linux operating systems, or an Oracle® database.

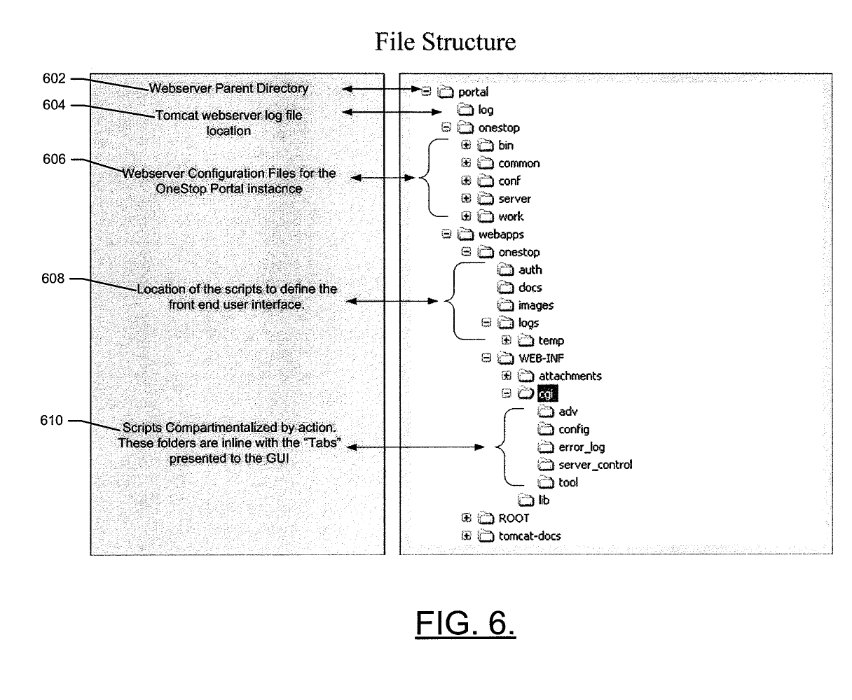

FIG. 6 illustrates a file structure of a web-based implementation of a graphical user interface for facilitating management of a computing system according to an exemplary embodiment of the invention. In this regard, FIG. 6 illustrates a file structure that may be used to support the system of FIG. 5. The file structure may include a web server parent directory 602. One of the child directories of the web server may include a directory 604 storing server log files (e.g., Tomcat web server log files). A plurality of directories 606 may store configuration files supporting the graphical user interface (e.g., the “One Stop Portal”) instance. A plurality of directories 608 may store scripts defining the front end of the graphical user interface. Further, a plurality of directories 610 may store selectable scripts to which access may be provided by the graphical user interface.

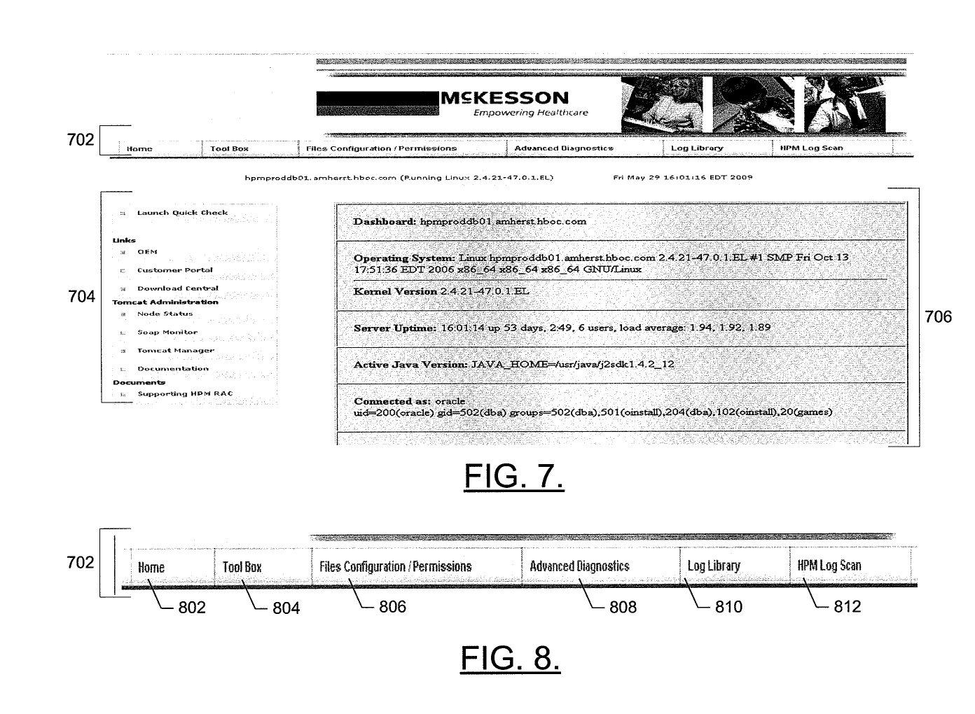

An exemplary embodiment of a graphical user interface that the system manager 228 may be configured to provide will now be described with respect to FIGS. 7-13. It will be appreciated that the layout and selection and arrangement of options presented in FIGS. 7-13 is provided by way of example of one embodiment of the graphical user interface and not by way of limitation. As illustrated in FIG. 7, the graphical user interface may comprise a plurality of sections. A first section may comprise a tabbed navigational bar 702, which may be used to navigate to different sections or categories of selectable access options to which access is provided by the graphical user interface. Another section of the graphical user interface may comprise a tool bar 704 for facilitating user access to system management tools in a graphical user interface for facilitating management of a computing system 306. In this regard, the tool bar may comprise links to information, documentation, manufacturer support information, and/or the like for facilitating management of the computing system 306. The graphical user interface may further comprise a section 706 that may be configured to display information, access options, and/or the like in response to user interaction with the navigational bar 702 and/or tool bar 704. In this regard, the navigational bar 702 and tool bar 704 may comprise static sections that may be displayed by the graphical user interface regardless of the content displayed in the section 706. The content illustrated in the section 706 in FIG. 7 may comprise home page content displayed to a user when the user first accesses the graphical user interface and/or selects a “Home” tab on the navigational bar 702. This content may provide information on an operating environment of the computing system 306, such as, for example, a version and/or type of operating system implemented on a server of the computing system 306, a kernel version of an operating system implemented on a server of the computing system 306, uptime of a server of the computing system 306, version(s) of software implemented on the computing system 306, a user ID by which a user is logged into the graphical user interface and/or computing system 306, and/or the like.

FIG. 8 illustrates a detailed screen shot of a portion of the tabbed navigational bar 702 according to an exemplary embodiment of the invention. As illustrated in FIG. 8, the navigational bar 702 may, for example, comprise a “Home” tab 802, “Tool Box” tab 804, “Files Configuration/Permissions” tab 806, “Advanced Diagnostics” tab 808, “Log Library” tab 810, and “HPM Log Scan” tab 812. The system manager 228 may be configured to determine a user selection of one of the tabs presented by the tabbed navigational bar 702 and cause content associated with the selected tab to be displayed by the graphical user interface in the section 706.

The Tool Box tab 804 may be associated with “tool box content” configured to provide point and click access to a system administrator's tool box of scripts. When the computing system 306 comprises multiple servers, such as a cluster of servers, the tool box content may provide access to information about each server. Further, the tool box content may provide access to integrity checks for the computing system 306, access to one or more searchable logs, and/or the like. In an exemplary embodiment in which the computing system 306 comprises an HPM computing system, the tool box content may provide access options for the following:

| | |
|---|---|
| HPM Scripts From /apg/admin/bin: | OneStop Custom Scripts: |
| Launch Check Servers from | Handoff Log: |
| Run Check Servers from each | Generate a Handoff log to |
| servers individually | /apg/admin/log/handoff.log |
| Fix Recurring Batch jobs | View Last Integrity Check |
| Restart All Application Servers | Health check Logs |
| Restart Local Services on | View / Scan Last |
| Stop Database | Health check |
| Start Database | Unlock Oracle |
| Stop Application Servers | Support Account |
| Start Application Servers | Support Portal Controls: |
| OEM Controls: | List Running Support |
| Check_OEM Status | Portal Processes |
| Start_OEM NOTE: Let this run, | Terminate Processes owned |
| may take some time | by the Support Portal |
| Stop_OEM NOTE: Let this run, | Check OneStop Support |
| may take some time | Portal Web Server logs |
| | Stop OneStop Support Portal |

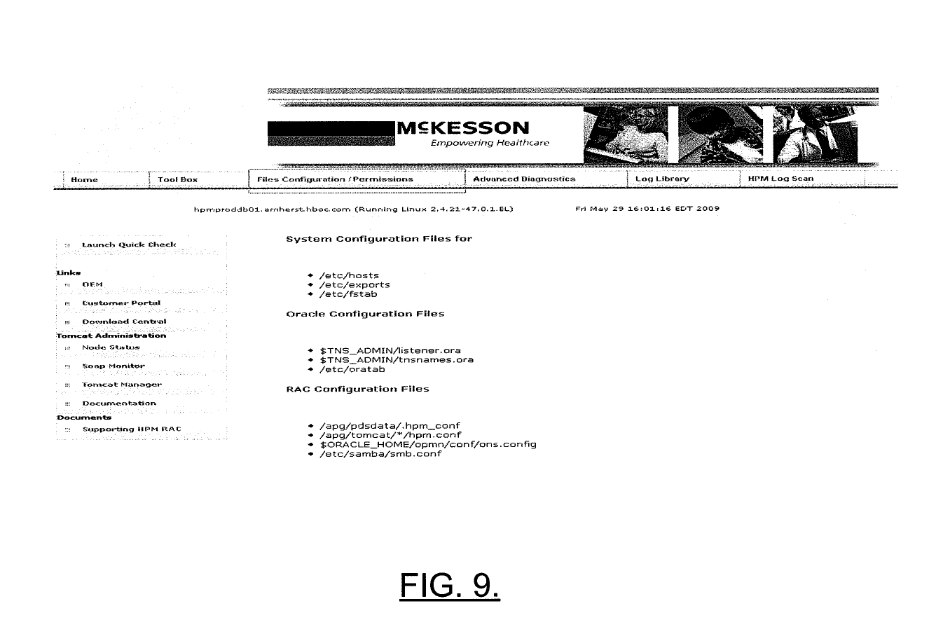

The Files Configuration/Permissions tab 806 may be associated with “file configuration content.” The file configuration content may comprise links to configuration files for the computing system 306 to enable the configuration files to be viewed within the graphical user interface in response to selection of a respective link. In this regard, the links to the configuration files may be configured to enable display of selected configuration files within a web browser. The configuration files may, for example, comprise configuration files for an application implemented by the computing system 306, an operating system implemented on a server of the computing system 306, a database implemented by the computing system 306, and/or the like. FIG. 9 illustrates file configuration content that may be displayed when the Files Configuration/Permissions tab 806 is selected. In an exemplary embodiment in which the computing system 306 comprises an HPM computing system, the file configuration content may provide access options for the following:

| | |
|---|---|
| System Configuration Files for | RAC Configuration Files |
| /etc/hosts | /apg/pdsdate.hpm_conf |
| /etc/exports | /apg/tomcat/*/hpm.conf |
| /etc/fstab | $ORACLE_HOME/opmn/conf/ |
| Oracle Configuration Files | ons.config/etc/samba/smb.conf |
| $TNS_ADMIN/listener.ora | Full APG Tree |
| $TNS_ADMIN/tnsnames.ora | APG Tree |
| /etc/oratab | 3m ownership and permissions |
| | 3m Tree |

The Advanced Diagnostics tab 808 may be associated with diagnostics content that may facilitate diagnosis of problems with the computing system 306. For example, the diagnostics content may comprise selectable pre-stored database queries. The system manager 228 may be configured to execute a selected pre-stored database query against a database implemented on the computing system 306. The system manager 228 may be further configured to cause the results of an executed pre-stored database query to be displayed by the graphical user interface (e.g., in a web-compatible format). The diagnostics content may further comprise other system diagnostics and triage options that may be selected by a user and then executed by the system manager 228. In an exemplary embodiment in which the computing system 306 comprises an HPM computing system having an Oracle® database, the diagnostics content may provide access options for the following:

| | |
|---|---|
| Oracle Database Queries | Oracle Diagnostics |
| Check Database Table Space | TNS Ping |
| Oracle Max Process Utilization | Check Oracle Listener |
| HPM_NODE table - IP_ADDRESS | Oracle Parameters |
| PERSIST_CLASS | Oracle Processes |
| Check Archive and Forced | Running |
| Logging Status | Oracle portlist.ini file |
| Check the Last Database | RAC Specific Diagnostics |
| Rounds Applied | crs_stat -t |
| Check the Oracle JVM | chkconfig nfs --list |
| and Java Packages | Reset the nfs |
| System Diagnostics | boot sequence |
| View Environmental Variables | System |
| System Disk usage | Memory / SWAP |
| Check Oracle Crontab | space and utilization |
| iostat | Check RPM code |
| Current Network Connections | levels / rpm -qa |
| Network Statistics | View NFS Statistics |
| Linux Kernel Parameters | CPU Utilization |
| Disk Space / Issue df command | Top 10 CPU |
| lsmod:list loaded modules | Consumers |
| APG file system disk usage | Ping all |
| List all Running Processes | Application Nodes |
| View All APG Running Processes | Ping all Database |
| All Nodes:View All APG | Nodes |
| Running Processes | Samba Diagnostics |
| View Running Job Manager | System Messages: |
| Processes | /var/log/messages |
| All Nodes:View Running | |
| Job Manager Processes | |
| View Running Word Sheet | |
| Manager Processes | |
| All Nodes:View Running Work | |
| Sheet Manager Processes | |
| View Runinng GR Processes | |
| All Nodes:View Running GR Processes | |

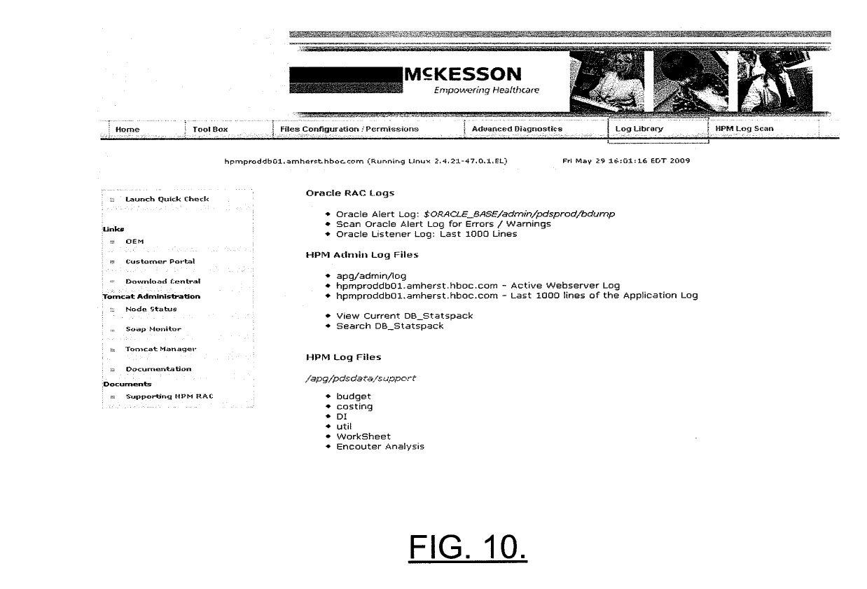

The Log Library tab 810 may be associated with log library content. The log library content may provide access to log files maintained by the computing system 306. In this regard, a user may select a log file and the system manager 228 may be configured to cause the selected log file to be displayed by the graphical user interface. The log library content may further comprise a scan option to scan for alerts and/or errors in one or more log files. The system manager 228 may accordingly be configured to initiate a scan of a log library and to cause the scan results to be displayed by the graphical user interface. FIG. 10 illustrates log library content that may be displayed when the Log Library tab 810 is selected. In an exemplary embodiment in which the computing system 306 comprises an HPM computing system, the log library content may provide access options for the following:

| | |
|---|---|
| Oracle RAC Logs | HPM Log Files |
| Oracle Alert Log: | /apg/pdsdata/support |
| $ORACLE_HOME/admin/ | budget |
| pdsprod/bdump | costing |
| Scan Oracle Alert Log for | DI |
| Errors / Warnings | util |
| Oracle Listener Log: | Worksheet |
| Last 1000 Lines | Encounter Analysis |
| HPM Admin Log Files | Grouping and Reimbursement |
| apg/admin/log | DSW LOGS |
| Active Webserver Log | HPM 11.X Version |
| Last 1000 lines of the | $DSW_OSLOG |
| Application Log | HPM 14.X Version |
| View Current DB_Statspack | $DSW_OSLOG |
| Search DB_Statspack | $DSW_SUPPORT_AUDIT |
| | $DSW_UPDATE |

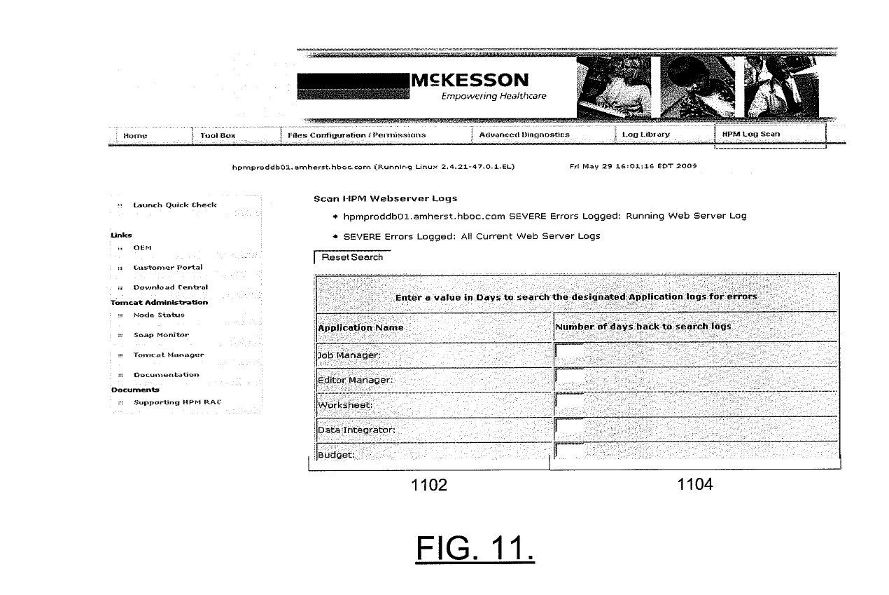

The HPM Log Scan tab 812 may be associated with a log scan interface. It will be appreciated that the embodiment illustrated in FIGS. 7-13 includes features customized for a computing system 306 comprising an HPM computing system. Accordingly, the HPM Log Scan tab 812 may provide access to a log scan interface for scanning an HPM log file(s). However, it will be appreciated that embodiments of the invention are not so limited and the graphical user interface may be configured to provide access to a log scan interface for scanning any log file(s). FIG. 11 illustrates a log scan interface for scanning HPM log files according to an embodiment of the invention. It will be appreciated that the layout of the interface is provided by way of example, and not by way of limitation. Further, it will be appreciated that a similar layout and scanning options may be provided for scanning other types of log files. The interface may comprise a table including a column 1102 listing a plurality of application log names. The table may further include a column 1104 providing an option for a user to define a period of time (e.g., a number of days) to search respective application logs for errors. The system manager 228 may accordingly be configured to determine a user selection of one or more application logs to be searched and a period of time to search respective application logs and in response to initiate a log search of selected application log(s) for the defined period(s) for errors. The system manager 228 may then be configured to cause the results of the log search to be displayed by the graphical user interface.

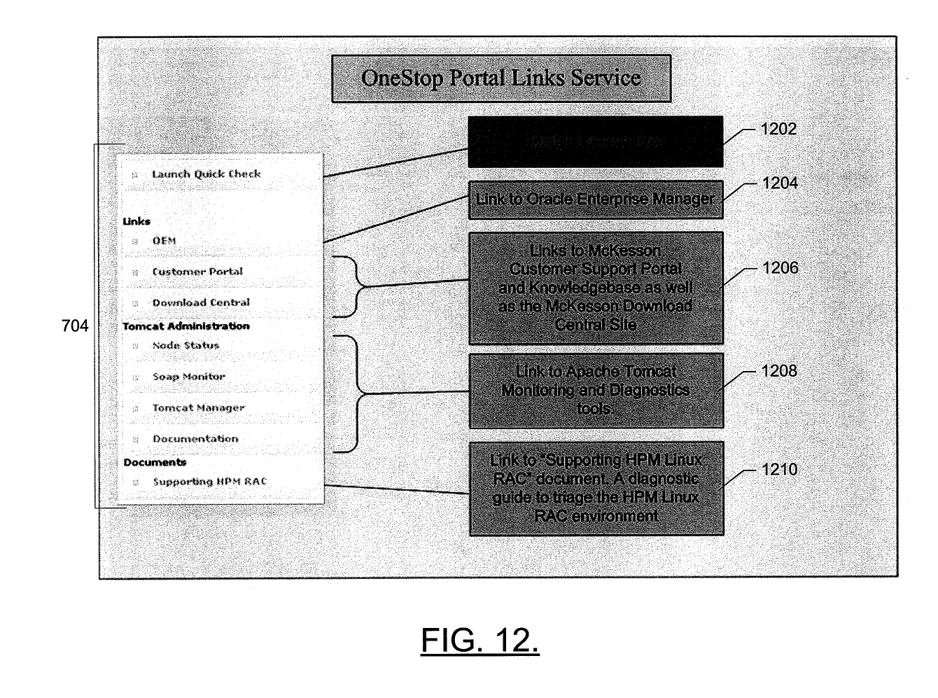

FIG. 12 illustrates a detailed screen shot of the tool bar 704. It will be appreciated that the embodiment of the tool bar 704 illustrated in FIG. 12 includes features customized for a computing system 306 comprising an HPM computing system. However, these customizations are provided by way of example and the tool bar 704 may include features tailored for any type of computing system 306. The tool bar 704 may include a quick launch tool 1202 that may provide quick launch access to a subset of access options provided by the graphical user interface. This subset of access options may comprise access options frequently accessed by a user. The access options provided by the quick launch tool 1202 may be customized based on the type of computing system implemented on the computing system 306 and/or may be user customizable such that, for example, a system administrator may select access options to be provided by the quick launch tool. In another alternative, the system manager 228 may be configured to track how often a user accesses respective access options and configure the quick launch tool 1202 to provide access to a predefined number of most frequently accessed access options. Access options that may be provided by the quick launch tool 1202 may include, for example, an option to determine server uptime, an option to determine web server start times, an option to perform a quick scan of one or more logs to determine “severe” errors in the web logs, an option to perform a scan of one or more logs to determine errors in the web logs, an option to display any known errors with the computing system 306, options to display information (e.g., start time, table space, and/or the like) about a database implemented on the computing system 306, and/or the like.

The tool bar 704 may further provide access to links to manufacturer supported system management information. For example, in embodiments wherein the computing system 306 comprises an HPM computing system, the tool bar 704 may provide a link 1204 to Oracle® Enterprise Manager and links 1206 to a McKesson® customer support portal, a McKesson® knowledge base, and a McKesson® download site for supporting HPM. The tool bar 704 may further provide a link(s) 1208 to tools for managing a web server, such as, for example, monitoring and diagnostics tools for the Apache Tomcat web server. The tool bar 704 may additionally provide link(s) to application documentation. Such links to application documentation may include, for example, a link 1210 to HPM Linux RAC (Oracle® Real Application Clusters) documentation in embodiments wherein the computing system 306 comprises an HPM computing system.

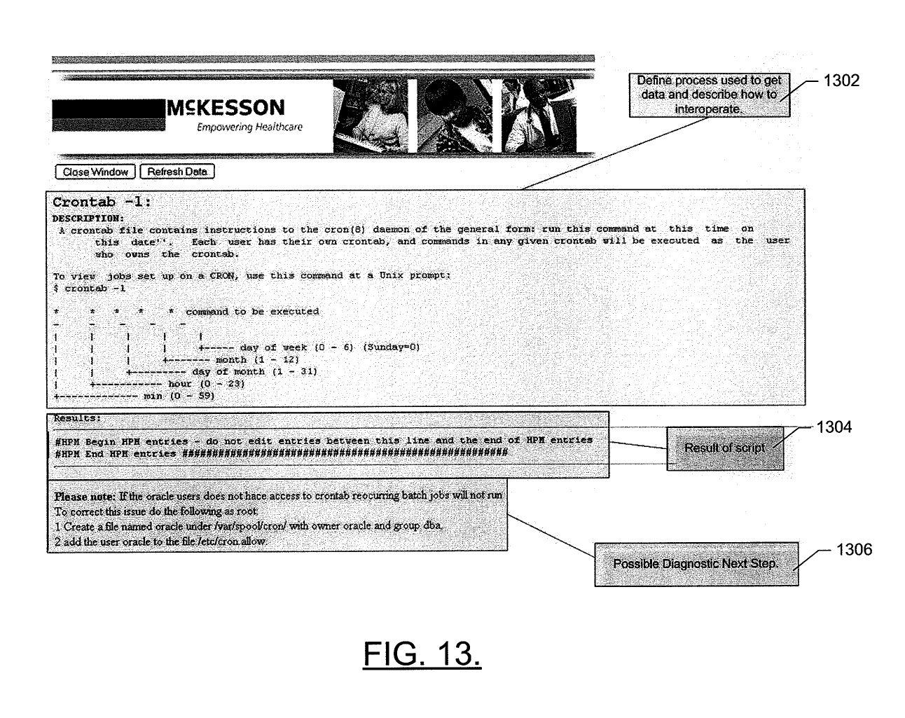

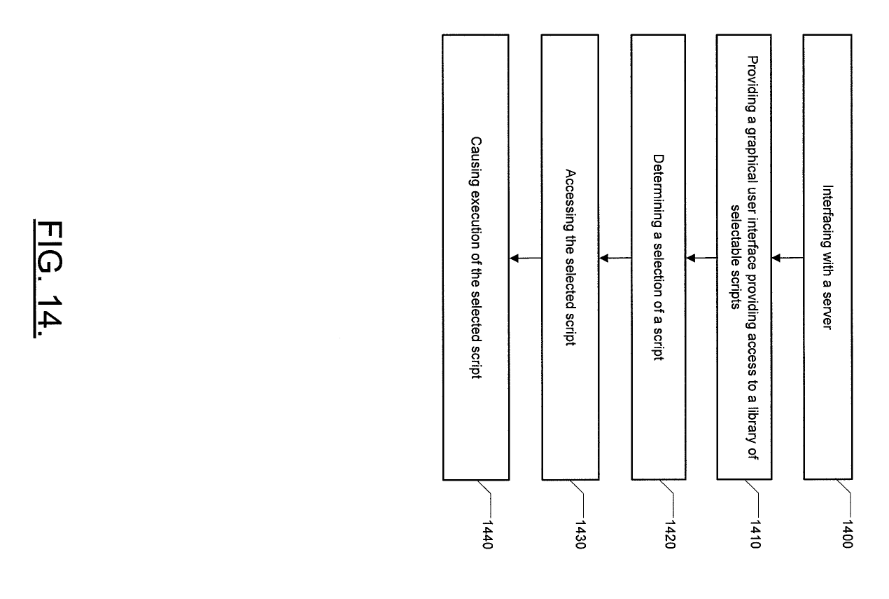

FIG. 13 illustrates information that may be provided to a user by a graphical user interface for facilitating management of a computing system according to an exemplary embodiment of the invention. In this regard, FIG. 13 illustrates user prompt and system management tutorial information that the system manager 228 may be configured to cause to be displayed on the graphical user interface. For example, the system manager 228 may be configured to cause information 1302 to be displayed that may describe an access option, such as, for example, a selectable script, to a user. The system manager 228 may be further configured to cause the results 1304 of an executed script to be displayed on the graphical user interface. The system manager 228 may additionally be configured to cause advice 1306 to be displayed that may provide information about a possible next diagnostic step. The displayed advice 1306 may be determined by the system manager 228 based on a previous diagnostic step and/or results of a previous diagnostic step (e.g., the results of execution of a script, log scan, and/or the like).

FIG. 14 illustrates a flowchart according to an exemplary method for facilitating management of a computing system according to an exemplary embodiment of the invention. The method may include the system manager 228 interfacing with a server (e.g., a server 402 or other server of the computing system 306), at operation 1400. Operation 1410 may comprise the system manager 228 providing a graphical user interface facilitating user management of the computing system 306. The graphical user interface provided by operation 1410 may be configured to provide access to a library of selectable scripts. The selectable scripts may be configured for execution on the server and may be configured to perform a management function when executed. Operation 1420 may comprise the system manager 228 determining a selection of a script. The system manager 228 may then access the selected script, at operation 1430. Operation 1440 may comprise the system manager 228 causing the selected script to be executed.

FIG. 14 is a flowchart of a system, method, and computer program product according to exemplary embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., the management apparatus 202, user terminal 308, a combination thereof, and/or the like) and executed by a processor (e.g., the processor 220) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing systems, personnel tasked with managing computing systems, environments in which computing systems are deployed, and users of computing systems. Embodiments of the invention provide for a graphical user interface facilitating user management of a computing system. In this regard, embodiments of the invention provide a graphical user interface serving as a one-stop portal for information and routines for managing a computing system. In some embodiments of the invention, the graphical user interface provides access to a library of selectable scripts configured for performing a management function when executed on a server of the computing system. Accordingly, by way of some embodiments of the invention, users are enabled to manage a computing system using an intuitive graphical interface without having to navigate a command line shell to perform system management functions. The graphical interface may accordingly aid in maintenance of a computing system such that system downtime may be reduced.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for facilitating management of a computing system comprising a server, the method comprising:
interfacing with the server; and
providing a graphical user interface facilitating user management of the computing system, the graphical user interface providing:
access to a library of selectable scripts configured for execution on the server, wherein each selectable script is configured to perform a management function when executed, the management function comprising a management function for managing one or more of the computing system, the server, an operating system implemented on the server, a database to which access is provided by the computing system, or an application provided by the computing system.

2. The method of claim 1, further comprising:
determining a selection via the graphical user interface of a script from the library of scripts;
accessing, in response to the selection, the selected script; and
causing execution of the selected script.

3. The method of claim 2, wherein at least a portion of the selected script is configured to execute in a location within a file system hierarchy on the server determined based at least in part upon the management function the selected script is configured to perform, and wherein causing execution of the selected script comprises causing execution of at least a portion of the selected script in the location within the file system hierarchy.

4. The method of claim 1, wherein providing the graphical user interface comprises providing, by a web server, a web-based graphical interface to a network terminal in network communication with the computing system such that the web-based graphical interface is displayable on a display in operative communication with the network terminal.

5. The method of claim 1, wherein the operating system implemented on the server comprises a version of Unix, Linix, or a Unix-like operating system, and wherein the scripts are configured for execution on the operating system implemented on the server.

6. The method of claim 1, wherein the graphical user interface further provides access to one or more searchable log libraries.

7. The method of claim 1, wherein interfacing with the server comprises executing a stand-alone process configured to interface with the server on the server or on a node in network communication with the server.

8. The method of claim 1, wherein the computing system comprises a system for healthcare data management.

9. An apparatus for facilitating management of a computing system comprising a server, the apparatus comprising a processor configured to cause the apparatus to:
interface with the server; and
provide a graphical user interface facilitating user management of the computing system, the graphical user interface providing:
access to a library of selectable scripts configured for execution on the server, wherein each selectable script is configured to perform a management function when executed, the management function comprising a management function for managing one or more of the computing system, the server, an operating system implemented on the server, a database to which access is provided by the computing system, or an application provided by the computing system.

10. The apparatus of claim 9, wherein the processor is further configured to cause the apparatus to:
determine a selection via the graphical user interface of a script from the library of scripts;
access, in response to the selection, the selected script; and
cause execution of the selected script.

11. The apparatus of claim 10, wherein at least a portion of the selected script is configured to execute in a location within a file system hierarchy on the server determined based at least in part upon the management function the selected script is configured to perform, and wherein the processor is configured to cause the apparatus to cause execution of the selected script by causing execution of at least a portion of the selected script in the location within the file system hierarchy.

12. The apparatus of claim 9, wherein the processor is configured to cause the apparatus to provide the graphical user interface by providing, by a web server, a web-based graphical interface to a network terminal in network communication with the computing system such that the web-based graphical interface is displayable on a display in operative communication with the network terminal.

13. The apparatus of claim 9, wherein the operating system implemented on the server comprises a version of Unix, Linix, or a Unix-like operating system, and wherein the scripts are configured for execution on the operating system implemented on the server.

14. The apparatus of claim 9, wherein the graphical user interface further provides access to one or more searchable log libraries.

15. The apparatus of claim 9, wherein the computing system comprises a system for healthcare data management.

16. The apparatus of claim 9, further comprising at least one memory storing instructions that when executed by the processor cause the apparatus to:
interface with the server; and
provide a graphical user interface facilitating user management of the computing system, the graphical user interface providing:
access to a library of selectable scripts configured for execution on the server, wherein each selectable script is configured to perform a management function when executed, the management function comprising a management function for managing one or more of the computing system, the server, an operating system implemented on the server, a database to which access is provided by the computing system, or an application provided by the computing system.

17. A computer program product for facilitating management of a computing system comprising a server, the computer program product comprising at least one computer-readable storage medium having computer-readable program instructions stored therein, the computer-readable program instructions comprising:
a program instruction configured for interfacing with the server; and
a program instruction configured for providing a graphical user interface facilitating user management of the computing system, the graphical user interface providing:
access to a library of selectable scripts configured for execution on the server, wherein each selectable script is configured to perform a management function when executed, the management function comprising a management function for managing one or more of the computing system, the server, an operating system implemented on the server, a database to which access is provided by the computing system, or an application provided by the computing system.

18. The computer program product of claim 17, further comprising:
a program instruction configured for determining a selection via the graphical user interface of a script from the library of scripts;
a program instruction configured for accessing, in response to the selection, the selected script; and
a program instruction configured for causing execution of the selected script.

19. The computer program product of claim 18, wherein at least a portion of the selected script is configured to execute in a location within a file system hierarchy on the server determined based at least in part upon the management function the selected script is configured to perform, and wherein the program instruction configured for causing execution of the selected script comprises instructions configured for causing execution of at least a portion of the selected script in the location within the file system hierarchy.

20. The computer program product of claim 17, wherein the program instruction configured for providing the graphical user interface comprises instructions configured for providing, by a web server, a web-based graphical interface to a network terminal in network communication with the computing system such that the web-based graphical interface is displayable on a display in operative communication with the network terminal.
